(19) United States
(12) Patent Application Publication
(10) Pub. No.: US 2021/0246283 A1
(43) Pub. Date: Aug. 12, 2021

(54) RESIN COMPOSITION AND RESIN MOLDED BODY

(71) Applicant: CANON KABUSHIKI KAISHA, Tokyo (JP)

(72) Inventors: Takahiro Kojima, Kanagawa (JP); Akira Yane, Tokyo (JP)

(21) Appl. No.: 17/153,088

(22) Filed: Jan. 20, 2021

(30) Foreign Application Priority Data
Feb. 7, 2020 (JP) 2020-019772

(51) Int. Cl. C08K 3/04

(52) U.S. Cl. CPC C08K 3/04; C08K 2201/001

(57) ABSTRACT

Provided is a resin composition having high conductivity, having a reduced variation in conductivity among pellets, and being excellent in surface appearance when injection-molded. The resin composition includes: a polyacetal; conductive carbon black; and graphite, wherein the conductive carbon black has a dibutyl phthalate oil absorption of 320 mL/100 g or less, wherein the content of the polyacetal in the resin composition is 50 mass % or more, wherein the content of the conductive carbon black in the resin composition is 11 mass % or more and 18 mass % or less, and wherein the conductive carbon black has a packed bulk density specified in JIS K 5101-12-2 of 0.14 g/mL or more and 0.25 g/mL or less.

### BACKGROUND OF THE INVENTION

### Field of the Invention

The present disclosure relates to a conductive resin composition and a conductive resin molded body each including a polyacetal resin.

### Description of the Related Art

A polyacetal (POM) resin is a resin having balanced mechanical properties and excellent slidability. In particular, the resin is excellent in slidability, and hence has been widely used in, for example, various precision mechanism parts typified by a gear and OA equipment, such as a copying machine. In particular, in recent years, the integration of members has been required in various applications, and hence a POM resin having a conductive filler added thereto in order to impart conductivity as a characteristic except the slidability has been applied to a member having performance by which static electricity generated at the time of its sliding is removed and a function as conductive wiring.

To deal with those applications, a conductive POM resin composition has started to be required to have excellent sliding abrasion stability in addition to stable conductive performance.

In Japanese Patent No. 5062843, there is a disclosure of a POM resin having improved thermal stability and high conductivity, the POM resin having blended therein conductive carbon black having a dibutyl phthalate oil absorption of 350 mL/100 g or more, graphite, a low-density polyethylene resin, an ester formed from a fatty acid and an aliphatic alcohol, and an epoxy compound.

### SUMMARY OF THE INVENTION

A resin composition of the present disclosure is a resin composition including: a polyacetal; conductive carbon black; and graphite, wherein a content of the polyacetal in the resin composition is 50 mass % or more, wherein a content of the conductive carbon black in the resin composition is 11 mass % or more and 18 mass % or less, wherein the conductive carbon black has a dibutyl phthalate oil absorption of 320 mL/100 g or less, and wherein the conductive carbon black has a packed bulk density specified in JIS K 5101-12-2 of 0.14 g/mL or more and 0.25 g/mL or less.

Further features of the present disclosure will become apparent from the following description of exemplary embodiments.

### DESCRIPTION OF THE EMBODIMENTS

In general, the dibutyl phthalate oil absorption of conductive carbon black is affected by a connection (structure) between carbon particles, and in general, carbon having a larger oil absorption tends to provide a resin composition having higher conductivity even when its blending amount is small. In Japanese Patent No. 5062843, an extremely high conductivity level is achieved by using the conductive carbon black having a dibutyl phthalate oil absorption of 350 mL/100 g or more while reducing the blending amount of the conductive agent. However, carbon black having a large oil absorption generally also has a low bulk density, and hence is difficult to knead into a resin composition. Carbon black having a low bulk density is liable to cause unevenness in addiction concentration, resulting in a variation in conductivity among pellets to be obtained after kneading. Accordingly, when such carbon black is used in a narrow conduction site, such as a mechanism part for a copying machine, a defective product with out-of-specification conduction may be produced. In addition, uniform dispersion becomes difficult, and hence the surface appearance of a molded body is liable to be degraded.

Modes for carrying out the present disclosure are described in detail below.

<<Conductive Resin Composition>>

A resin composition of the present disclosure is a resin composition including a polyacetal as a main component, and further includes conductive carbon black and graphite. By virtue of combining the conductive carbon black and the graphite, a material having high conductivity and high slidability is obtained. The constituent components of the resin composition of the present disclosure are described below.

<Polyacetal>

Typical examples of the polyacetal may include: a polyacetal homopolymer substantially formed only of an oxymethylene unit, which is obtained by subjecting a formaldehyde monomer or a multimer thereof (e.g., trioxane) to homopolymerization; and a polyacetal copolymer, which is obtained by subjecting a formaldehyde monomer or a multimer thereof (e.g., trioxane) and a glycol, a cyclic ether, or a cyclic formal, such as ethylene oxide, propylene oxide, epichlorohydrin, or 1,3-dioxolane, to copolymerization. The polyacetal copolymer may be preferably used in terms of chemical stability. In addition, a polyacetal copolymer having a crosslinked structure or a block structure may be used in accordance with the kind of the copolymer, and the structural feature of the polyacetal copolymer is not particularly limited.

Although the terminal structure of the polymer is also not particularly limited, when a hydroxy group of the oxymethylene unit or an aldehyde is present in a terminal portion thereof, the terminal portion may serve as the starting point of the thermal decomposition of the polymer. There is preferably used a polyacetal resin obtained by subjecting a terminal of the oxymethylene unit to a chemical sealing treatment, or subjecting the unstable terminal portion to a decomposition treatment with any one of, for example, amines and an ammonium compound, to cause a copolymer component except the oxymethylene unit to serve as a terminal.

The polyacetal has a melt flow rate (MFR, measured under JIS-K 7210 conditions) at 190° C. of preferably from 0.5 g/10 min to 100 g/10 min, more preferably from 1 g/10 min to 50 g/10 min.

A commercial polyacetal may be used as the polyacetal. Specific examples thereof include: the DURACON (trademark) series manufactured by Polyplastics Co., Ltd.; the TENAC (trademark) series and the TENAC (trademark) -C series each manufactured by Asahi Kasei Corporation; and the Iupital (trademark) series manufactured by Mitsubishi Engineering-Plastics Corporation. In addition, those polyacetal resins may be mixed with each other.

The content of the polyacetal in the resin composition is 50 mass % or more from the viewpoint of securing the original slidability and strength of the polyacetal, and is preferably 70 mass % or more. Herein, the content in the resin composition refers to a content when the entirety of the resin composition is defined as 100 mass %.

<Conductive Carbon Black>

The conductive carbon black is carbon black having a developed chain structure. Carbon black having an average primary particle diameter as an aggregate (aggregate diameter) in the range of 0.05 μm or more and 1 μm or less is preferably used.

The conductive carbon black has a dibutyl phthalate (DBP) oil absorption (ASTM D2415-65T) of 320 mL/100 g or less, preferably 300 mL/100 g or less, more preferably 250 mL/100 g or less. In addition, from the viewpoint of enhancing conductivity, the DBP oil absorption is preferably 150 mL/100 g or more. In addition, the conductive carbon black has a packed bulk density specified in JIS K 5101-12-2 of 0.14 g/mL or more and 0.25 g/mL or less, preferably 0.14 g/mL or more and 0.19 g/mL or less. Meanwhile, carbon black having a DBP oil absorption of 320 mL/100 g or less and a packed bulk density of 0.25 g/mL or less has a sufficiently large primary particle diameter and is aggregated loosely, and hence is excellent in dispersibility. The packed bulk density is more preferably 0.19 g/mL or less in terms of the appearance of the resin composition after its molding. In addition, when the packed bulk density is 0.14 g/mL or more, carbon powder is hardly scattered at the time of kneading in melt-kneading, and a resin composition using conductive carbon black satisfying those conditions can reduce a variation in conductivity among pellets to be obtained after the kneading.

The content of the conductive carbon black in the resin composition is 11 mass % or more and 18 mass % or less, preferably 11 mass % or more and 14 mass % or less. When the content of the conductive carbon black is less than 11 mass %, sufficient conductivity is not satisfied. When the content is more than 18 mass %, heat generation at the time of molding is increased, and hence thermal decomposition is also liable to occur.

Specific examples of the conductive carbon black include: DENKA BLACK (trademark) (DBP oil absorption of a particulate product: 160 mL/100 g) manufactured by Denki Kagaku Kogyo Kabushiki Kaisha; the SEAST (product name) series (DBP oil absorption: 40 mL/100 g to 160 mL/100 g) and the TOKABLACK (product name) series (DBP oil absorption: 50 mL/100 g to 170 mL/100 g) each manufactured by Tokai Carbon Co., Ltd.; the Mitsubishi Carbon Black (product name) series (DBP oil absorption: 40 mL/100 g to 180 mL/100 g) manufactured by Mitsubishi Chemical Corporation; and products each having a DBP oil absorption of more than 250 mL/100 g, such as the LIONITE (product name) EC series (DBP oil absorption: 250 mL/100 g to 300 mL/100 g) from Lion Specialty Chemicals Co., Ltd. and the Vulcan (product name) series from Cabot Corporation. In addition, two or more kinds of carbon black may be used in combination.

<Graphite>

The graphite may be appropriately selected from an artificial product and a natural product in accordance with purposes. The shape of the graphite is not particularly limited, and any one of, for example, a flaky shape, a lump shape, a spherical shape, and an earthy shape is permitted, but flaky graphite is preferred from the viewpoint of the expression of more satisfactory conductivity.

The average particle diameter of the graphite preferably falls within the range of 0.5 μm or more and 100 μm or less, and more preferably falls within the range of 20 μm or more and 80 μm or less. The average particle diameter is preferably 0.5 μm or more from the viewpoints of high conductivity and dimensional stability at the time of a temperature change, and is preferably 100 μm or less from the viewpoints of handleability and the surface property of a molded body.

A specific example of the graphite is flaky graphite, such as: the CP (product name) series and the F# (product name) series each manufactured by Nippon Graphite Industries, Co., Ltd.; and the CNP (product name) series and the Z (product name) series each manufactured by Ito Graphite Co., Ltd. In addition, two or more kinds of graphite may be used in combination.

The content of the graphite in the resin composition is preferably 2 mass % or more and 8 mass % or less. When the content of the graphite is 2 mass % or more, at a time when the resin composition is slid as a molded body, a change in conductivity thereof before and after the sliding can be reduced. In addition, when the content is 8 mass % or less, the abrasion durability of the molded body can be made sufficient.

<Decomposition Inhibitor>

The resin composition of the present disclosure may include a decomposition inhibitor for inhibiting the decomposition of the polyacetal as required. When the resin composition includes the decomposition inhibitor, the content thereof in the resin composition is preferably 0.5 mass % or more and 2.5 mass % or less.

Examples of the decomposition inhibitor include an epoxy compound, a polyamide resin, a polymer of acrylamide, an amide compound, an amino-substituted triazine compound and a derivative thereof, urea and a derivative thereof, a hydrazine derivative, an imidazole compound, and an imide compound. Of those, an epoxy compound, in particular, a phenol novolac-type epoxy resin compound may be more suitably used. The mechanism via which the phenol novolac-type epoxy resin effectively acts is unclear, but is conceivably as described below. That is, it is conceived that the phenol novolac-type epoxy resin may be adsorbed on the conductive carbon black or the graphite through an electronic interaction between the aromatic ring of phenol and the conductive carbon black or the graphite having conductive carbon atoms in sp² hybrid orbitals. Organic functional groups each having an active proton, which are present on the surfaces of the conductive carbon black and the graphite, may each serve as a decomposition reaction site for the polyacetal, but the phenol novolac-type epoxy resin is expected to effectively inhibit a decomposition reaction by reacting with the decomposition reaction site. The phenol novolac-type epoxy resin is specifically a condensate of phenol novolac or cresol novolac and epichlorohydrin, and its epoxy equivalent preferably falls within the range of 150 or more and 250 or less.

In addition, when the resin composition includes the epoxy compound, the resin composition preferably includes a curing agent and a curing accelerator in order to accelerate the ring-opening reaction of an epoxy group and to allow an unreacted epoxy residue to react. Examples of the curing agent and the curing accelerator include, but not particularly limited to, an imidazole, a secondary amine, a tertiary amine, a morpholine compound, dicyandiamide, melamine, urea and a derivative thereof, and a phosphorus compound, such as triphenylphosphine. In addition, those compounds may be added alone or in combination thereof.

<Slidability-Improving Agent>

The resin composition of the present disclosure may include a slidability-improving agent as required. When the resin composition includes the slidability-improving agent, the content thereof in the resin composition is preferably 10 mass % or less for the purpose of securing a balance among slidability, thermal deformation temperature, and a torque reduction amount at the time of kneading, and low thermal expansivity.

Examples of the slidability-improving agent include a fatty acid ester, a polyolefin, and a polysiloxane. Of those, a fatty acid ester may be suitably used because the ester is effective in improving slidability and alleviating a kneading torque at the time of the production of the resin composition. In addition, a polyolefin such as polyethylene, which is effective in, for example, reducing abrasion at the time of sliding, may also be suitably used. The fatty acid ester is specifically preferably an ester of a monovalent fatty acid and a monohydric aliphatic alcohol. A monovalent fatty acid that is naturally derived and easily available is, for example, myristic acid, stearic acid, montanic acid, oleic acid, linoleic acid, or linolenic acid, and an ester obtained from any such acid and an aliphatic alcohol may be suitably used. In particular, cetyl myristate or stearyl stearate is more preferred in terms of balance among characteristics such as slidability, a thermal deformation temperature, and a torque reduction amount at the time of kneading.

<Other Components>

The resin composition of the present disclosure may include other components as required to such an extent that the effects of the present disclosure are not impaired. As various additives for improving functionalities, there are given: lubricants and release agents, such as waxes, various fatty acids, fatty acid amides, fatty acid esters, and fatty acid metal salts; various antistatic agents; formic acid scavengers, such as melamine and a hydroxide and a carbonate of an alkali metal; impact resistance-improving agents, such as a polyurethane elastomer, a polyester elastomer, and a polystyrene elastomer; and flame retardants, such as organophosphorus compounds. In addition, as various additives for improving long-term stability, there are given: UV absorbers, such as a benzotriazole-based compound, a benzophenone-based compound, and a phenyl salicylate compound; hindered amine-based light stabilizers; hindered phenol-based antioxidants; and the like. The total content of those components is preferably 10 mass % or less, more preferably 3 mass % or less with respect to the resin composition. When the content is set to 10 mass % or less, a resin composition that does not impair the heat resistance and slidability of the polyacetal can be obtained.

In addition, an inorganic component, such as a metal oxide, a metal hydroxide, a carbonate, a sulfate, a silicate compound, a glass-based filler, a silicic acid compound, metal powder or a metal fiber, a carbon fiber, or a carbon nanotube, may be incorporated for the purpose of improving a function of the resin composition, such as a low thermal expansion rate or rigidity, to such an extent that the conductive performance of the present disclosure is not impaired. Examples of the metal oxide include alumina, zinc oxide, titanium oxide, cerium oxide, calcium oxide, magnesium oxide, iron oxide, tin oxide, and antimony oxide. Examples of the metal hydroxide include calcium hydroxide, magnesium hydroxide, and aluminum hydroxide. Examples of the carbonate include basic magnesium carbonate, calcium carbonate, magnesium carbonate, zinc carbonate, barium carbonate, dawsonite, and hydrotalcite. Examples of the sulfate include calcium sulfate, barium sulfate, magnesium sulfate, and a gypsum fiber. Examples of the silicate compound include calcium silicate (e.g., wollastonite or xonotlite), talc, clay, mica, montmorillonite, bentonite, activated earth, sepiolite, imogolite, sericite, kaolin, vermiculite, and smectite. Examples of the glass-based filler include a glass fiber, a milled glass fiber, glass beads, glass flakes, and glass balloons. Examples of the silicic acid compound include silica (e.g., white carbon) and silica sand. As a main element for forming the metal powder or the metal fiber, there are given, for example, iron, aluminum, titanium, and copper, and a composite of any such element and another element may also be adopted. The surfaces of those inorganic components may be treated with, for example, various surface treatment agents, such as a silane coupling agent, a titanium coupling agent, an organic fatty acid, an alcohol, and an amine, a wax, and a silicone resin.

<Determination of Constituent Components>

The constituent components of the resin composition of the present disclosure may be known by combining a known separation technology and a known analysis technology. Although a method and a procedure for the separation and the analysis are not particularly limited, for example, the following may be performed: a solution is obtained by extracting organic components from the resin composition, and its components are separated by, for example, various kinds of chromatography, followed by further component analysis.

To extract the organic components from the resin composition, the resin composition only needs to be dissolved in a solvent in which the organic components are soluble. A time period required for the extraction can be shortened by finely crushing the resin composition in advance or by stirring the solvent under heating. Although the solvent to be used may be arbitrarily selected in accordance with the properties of the organic components for forming the resin composition, a solvent such as hexafluoropropanol is suitably used.

Herein, the content of an inorganic component in the resin composition may be known by drying and weighing the residue remaining after the separation of the organic components. In addition to the foregoing, the following method is available as a method of knowing the content of the inorganic component of the resin composition: the temperature of the resin composition is increased to a temperature equal to or more than the decomposition temperature of the resin by thermogravimetric analysis (TGA) or the like, and an ash content is determined.

From the solution obtained by extracting the organic components from the resin composition, the components may be separated by methods such as various kinds of chromatography. Low-molecular weight additives may be separated by gas chromatography (GC) or high performance liquid phase column chromatography (HPLC), and a high-molecular weight polymer may be separated by gel permeation chromatography (GPC) or the like. In particular, when the solution contains a crosslinked polymer or gel having a large molecular weight, or when a micelle is formed in the solution, centrifugal separation or separation with a semipermeable membrane may be selected. The separated organic components may be analyzed by a known analysis approach, such as nuclear magnetic resonance (NMR) spectrum measurement, infrared absorption (IR) spectrum measurement, Raman spectrum measurement, mass spectrum measurement, or elemental analysis.

In particular, the conductive carbon black, the graphite, and components chemically bonded to their surface functional groups may be recovered from a residue obtained by centrifugal separation after other organic components have been extracted through dissolution in a solvent capable of dissolving the other organic components. The residue may be separated into fragments of the respective components through appropriate chemical treatment, such as treatment with a strong acid or the like. After soluble components have been fractionated by centrifugal separation and then neutralized, followed by solvent removal and washing, their structures may be identified by a known analysis approach. Examples of the known analysis approach include gas chromatography (GC), high performance liquid phase column chromatography (HPLC), nuclear magnetic resonance (NMR) spectrum measurement, infrared absorption (IR) spectrum measurement, Raman spectrum measurement, mass spectrum measurement, and elemental analysis.

<Method of Producing Resin Composition>

A method of producing the resin composition is not limited to a specific method, and a mixing method that has been generally adopted for a thermoplastic resin may be used. For example, the composition may be produced by mixing and kneading with a mixing machine, such as a tumbler, a V-type blender, a Banbury mixer, a kneading roll, a kneader, a single-screw extruder, or a multi-screw extruder having two or more screws. In particular, melting and kneading with a twin-screw extruder are excellent in productivity.

A plurality of components out of the polyacetal, the conductive carbon black, the graphite, and the other components to be used as required may be preliminarily mixed or preliminarily kneaded in advance, or all the components may be simultaneously mixed or kneaded. In particular, in the production thereof with an extruder, the following kneading may be performed: an individual feeder is arranged for each component, and sequential addition is performed in an extrusion process. When the other component is preliminarily mixed with one or a plurality of the polyacetal, the conductive carbon black, and the graphite, the mixture only needs to be treated by a dry method or a wet method. The dry method includes stirring the components with a stirring machine, such as a Henschel mixer or a ball mill. The wet method includes: adding the thermoplastic resin to a solvent; stirring the mixture; and drying and removing the solvent after the mixing.

In the production of the resin composition by the melting and kneading of the components, a kneading temperature, a kneading time, and a feeding rate may be arbitrarily set in accordance with the kind and performance of a kneading apparatus, and the properties of the components. The kneading temperature is typically 150° C. or more and 250° C. or less, preferably 160° C. or more and 230° C. or less, more preferably 170° C. or more and 210° C. or less. When the kneading temperature is excessively low, the dispersion of the conductive carbon black and the graphite is inhibited, and when the temperature is excessively high, the thermal decomposition of the polyacetal becomes a problem, and hence formaldehyde may be produced or reductions in various physical properties may occur.

<<Resin Molded Body>>

A resin molded body of the present disclosure is a resin molded body including a polyacetal, conductive carbon black, and graphite, wherein the conductive carbon black has a dibutyl phthalate oil absorption of 320 mL/100 g or less. The content of the polyacetal in the resin molded body is 50 mass % or more. The content of the conductive carbon black in the resin molded body is 11 mass % or more and 18 mass % or less, preferably 11 mass % or more and 14 mass % or less. The conductive carbon black has a packed bulk density specified in JIS K 5101-12-2 of 0.14 g/mL or more and 0.25 g/mL or less, preferably 0.14 g/mL or more and 0.19 g/mL or less.

The resin molded body of the present disclosure may be obtained by molding the resin composition of the present disclosure. The resin composition of the present disclosure may be easily molded by a molding method that has been generally used, such as extrusion molding, injection molding, or compression molding, and may also be applied to blow molding, vacuum molding, two-color molding, insert molding, or the like. The resin molded body is applied as a part for OA equipment or other electrical and electronic equipment, or a conductive functional part for electrical and electronic equipment. In addition, the resin molded body may also be applied to, for example, a structural member for an automobile, an aircraft, or the like, a building member, or a food container. That is, the resin molded body may be applied to various production methods each including molding a resin composition with a mold to produce a resin molded body, and in particular, may be suitably used in a mechanism part for each of a copying machine main body and a toner cartridge container, which is required to have high conductivity and high slidability. In particular, the resin molded body is suitably used in a member having a narrow conduction site because a defective product with out-of-specification conduction is hardly produced. In addition, the resin molded body and resin member of the present disclosure are excellent in conductivity and dimensional stability, and hence are suitably used in, for example, an electrical contact member in electrical and electronic equipment, or a photosensitive drum flange, a process cartridge part, or a bearing member in an image-forming apparatus.

### EXAMPLES

Raw materials commonly used in Examples (including Comparative Examples) are as described below. The packed bulk density of conductive carbon black is as shown in Table 1. With regard to the packed bulk density, a bulk density was measured based on Apparent Density or Apparent Specific Volume—Mechanically Tamped Packing Method specified in JIS K 5101-12-2, and was adopted as the packed bulk density.

(A) Polyacetal

“DURACON (trademark) M270CA” (product name) manufactured by Polyplastics Co., Ltd.

(B) Conductive Carbon Black

<B-1> “LIONITE EC200L” (product name) manufactured by Lion Specialty Chemicals Co., Ltd., (DBP oil absorption: 260 mL/100 g)
<B-2> “Vulcan XCmax22” (product name) manufactured by Cabot Corporation, (DBP oil absorption: 320 mL/100 g)
<B-3> “DENKA BLACK” (trademark) manufactured by Denki Kagaku Kogyo Kabushiki Kaisha (DBP oil absorption of a particulate product: 160 mL/100 g)
<B-4> “PRINTEX XE-2B” (product name) manufactured by Orion Engineered Carbons (DBP oil absorption: 420 mL/100 g)
<B-5> Powder obtained by spray-applying 1 wt % pure water onto “CARBON ECP200L” (product name) manufactured by Lion Specialty Chemicals Co., Ltd., and granulating the resultant with a pan-type dry granulator “DPZ-01R” manufactured by AS ONE Corporation at 20 rpm for 1 hour, followed by drying at 100° C. for 6 hours (DBP oil absorption: 260 mL/100 g)

(C) Graphite

Flaky Graphite “Z-25” (product name) manufactured by Ito Graphite Co., Ltd., average particle diameter: 25 μm

(D) Decomposition Inhibitor

<D-1> Cresol novolac-type epoxy resin “EPICLON-695” (product name) manufactured by DIC Corporation
<D-2> Triphenylphosphine manufactured by Kishida Chemical Co., Ltd. (used as an epoxy curing accelerator)
<D-3> Dicyandiamide manufactured by Kishida Chemical Co., Ltd. (used as an epoxy curing agent)

(E) Slidability-Improving Agent

<E-1> “SPERMACETI” (product name) manufactured by NOF Corporation (main component: cetyl myristate)
<E-2> “UBE Polyethylene L719” (product name) manufactured by Ube-maruzen Polyethylene

### Examples 1 to 6 and Comparative Examples 1 to 3

The polyacetal (A) was dried at a temperature of 90° C. for 3 hours in advance. After that, the component (B) to the component (E) were added so that the mass % of each component in a composition became a blending amount shown in each of Examples and Comparative Examples in Table 1. Thus, a blend of the raw materials was produced. The blend was melt-kneaded with a twin-screw extruder “PCM30” (product name) manufactured by Ikegai Corp. under the condition of a cylinder temperature of 200° C. to produce a strand, which was cut with a pelletizer to provide a pellet of a resin composition. In each of Examples 5 and 6, and Comparative Example 1, the content of the conductive carbon black (B) was adjusted so that the conductivity of the resin composition to be obtained became comparable to that of Example 1.

For each of Examples and Comparative Examples, evaluations were performed by the following methods. The results are shown in Table 1.

<Evaluation of Volume Resistivity of Resin Composition>

The resin composition was portioned out under the state of the strand immediately before the cutting for pelletization, and its diameter was measured with calipers. The resistance value of a range having a length of 5 cm was measured with HANDY MILLI-OHM TESTER “SK-3800” (product name) manufactured by Kaise Corporation, and the volume resistivity of the resin composition was calculated. The measurement was performed 4 times for different strands, and the mean and standard deviation (σ) of volume resistivities were determined.

<Evaluation of Fluidity, and Evaluation of Surface Appearance of Molded Body>

The obtained pellet was subjected to injection molding with an injection molding machine “SE-180D” (product name) manufactured by Sumitomo Heavy Industries, Ltd. at a cylinder temperature of 200° C. and a mold temperature of 60° C. For the evaluation of fluidity, an Archimedean spiral flow mold (measuring 5 mm wide by 2 mm thick) was used, and filling lengths of the resin were compared.

In addition, a bar test specimen type B1 (measuring 80 mm long by 10 mm wide by 4 mm thick) specified in JIS K7152-1 was produced. The surface appearance of the test specimen was checked, and a case in which a microvoid due to dispersion failure of the carbon black or thermal decomposition of the resin was observed on the molded surface was graded as “B” and a case in which no such microvoid was observed was graded as “A”.

TABLE 1

| | | Example | | | | | | | Comparative Example | | | |
|---|---|---|---|---|---|---|---|---|---|---|---|---|
| | | 1 | 2 | 3 | 4 | 5 | 6 | 7 | 1 | 2 | 3 | 4 |
| A | Blending | 72.675 | 71.675 | 70.675 | 69.675 | 71.675 | 65.675 | 75.500 | 76.675 | 72.675 | 73.675 | 63.675 |
| | amount | | | | | | | | | | | |
| | [wt %] | | | | | | | | | | | |
| B | Kind | B-1 | B-1 | B-1 | B-1 | B-2 | B-3 | B-3 | B-4 | B-5 | B-1 | B-3 |
| | Blending | 11 | 12 | 13 | 14 | 12 | 18 | 18 | 7 | 11 | 10 | 20 |
| | amount | | | | | | | | | | | |
| | [wt %] | | | | | | | | | | | |
| | DBP oil | 260 | 260 | 260 | 260 | 320 | 160 | 160 | 420 | 260 | 260 | 160 |
| | absorption | | | | | | | | | | | |
| | [mL/100 g] | | | | | | | | | | | |
| | Packed | 0.15 | 0.15 | 0.15 | 0.15 | 0.19 | 0.25 | 0.25 | 0.13 | 0.08 | 0.15 | 0.25 |
| | bulk | | | | | | | | | | | |
| | density | | | | | | | | | | | |
| | [g/mL] | | | | | | | | | | | |
| C | Blending | 4 | 4 | 4 | 4 | 4 | 4 | 4 | 4 | 4 | 4 | 4 |
| | amount | | | | | | | | | | | |
| | [wt %] | | | | | | | | | | | |
| D-1 | Blending | 1.5 | 1.5 | 1.5 | 1.5 | 1.5 | 1.5 | 0 | 1.5 | 1.5 | 1.5 | 1.5 |
| | amount | | | | | | | | | | | |
| | [wt %] | | | | | | | | | | | |
| D-2 | Blending | 0.75 | 0.75 | 0.75 | 0.75 | 0.75 | 0.75 | 0 | 0.75 | 0.75 | 0.75 | 0.75 |
| | amount | | | | | | | | | | | |
| | [wt %] | | | | | | | | | | | |
| D-3 | Blending | 0.075 | 0.075 | 0.075 | 0.075 | 0.075 | 0.075 | 0 | 0.075 | 0.075 | 0.075 | 0.075 |
| | amount | | | | | | | | | | | |
| | [wt %] | | | | | | | | | | | |
| E-1 | Blending | 2.5 | 2.5 | 2.5 | 2.5 | 2.5 | 2.5 | 2.5 | 2.5 | 2.5 | 2.5 | 2.5 |
| | amount | | | | | | | | | | | |
| | [wt %] | | | | | | | | | | | |
| E-2 | Blending | 7.5 | 7.5 | 7.5 | 7.5 | 7.5 | 7.5 | 0 | 7.5 | 7.5 | 7.5 | 7.5 |
| | amount | | | | | | | | | | | |
| | [wt %] | | | | | | | | | | | |
| Resis- | Mean | 13 | 8 | 4 | 4 | 13 | 11 | 12 | 17 | 13 | 45 | 9 |
| tivity | [Ω · cm] | | | | | | | | | | | |
| | Deviation | 1.0 | 0.6 | 0.7 | 0.5 | 1.3 | 0.6 | 0.9 | 4.7 | 3.8 | 2.3 | 2.0 |
| | [u] | | | | | | | | | | | |

| | | | | | | | | | | | |
|---|---|---|---|---|---|---|---|---|---|---|---|
| Fluidity [cm] | 21 | 20 | 18 | 16 | 17 | 12 | 10 | 21 | 20 | 23 | 8 |
| Surface appearance | A | A | A | A | A | A | A | B | A | A | B |

From the comparison of Example 1 to Comparative Examples 1 and 2 in Table 1, it is found that the resin composition of the present disclosure has a small deviation in resistivity, and hence has a reduced variation in conductivity among pellets. At the same time, it is found that the resin composition of the present disclosure has high conductivity, has satisfactory molding fluidity, and has provided a molded body excellent in surface appearance with the carbon black being sufficiently dispersed. As shown in Comparative Example 3, when the content of the conductive carbon black (B) was 10 mass % or less, a region in which a rise in internal resistivity was exponentially increased with respect to the reduction in content of the conductive carbon black (B) was formed, and the influence of a variation in concentration significantly appeared in the form of a variation in conductivity. In addition, as shown in Comparative Example 4, when the content of the conductive carbon black was more than 18 wt %, the thermal decomposition of the resin progressed to degrade the surface appearance.

The present disclosure is not limited to the embodiments and Examples described above, and many modifications may be performed within the technical idea of the present disclosure. In addition, the effects described in the embodiments and Examples of the present disclosure are merely examples of the most suitable effect arising from the present disclosure, and the effects according to the present disclosure are not limited to those described in the embodiments and Examples.

According to the present disclosure, the conductive polyacetal resin composition having high conductivity, having a reduced variation in conductivity among pellets, and being excellent in surface appearance when injection-molded, and the resin molded body molded out of the composition can be obtained.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-019772, filed Feb. 7, 2020, which is hereby incorporated by reference herein in its entirety.

What is claimed is:

1. A resin composition comprising:
a polyacetal;
conductive carbon black; and
graphite,
wherein a content of the polyacetal in the resin composition is 50 mass % or more,
wherein a content of the conductive carbon black in the resin composition is 11 mass % or more and 18 mass % or less,
wherein the conductive carbon black has a dibutyl phthalate oil absorption of 320 mL/100 g or less, and
wherein the conductive carbon black has a packed bulk density specified in JIS K 5101-12-2 of 0.14 g/mL or more and 0.25 g/mL or less.

2. The resin composition according to claim 1,
wherein the content of the conductive carbon black is 11 mass % or more and 14 mass % or less.

3. The resin composition according to claim 1,
wherein the packed bulk density of the conductive carbon black is 0.14 g/mL or more and 0.19 g/mL or less.

4. A resin molded body comprising:
a polyacetal;
conductive carbon black; and
graphite,
wherein a content of the polyacetal in the resin molded body is 50 mass % or more,
wherein a content of the conductive carbon black in the resin molded body is 11 mass % or more and 18 mass % or less,
wherein the conductive carbon black has a dibutyl phthalate oil absorption of 320 mL/100 g or less, and
wherein the conductive carbon black has a packed bulk density specified in JIS K 5101-12-2 of 0.14 g/mL or more and 0.25 g/mL or less.

5. The resin molded body according to claim 4,
wherein the content of the conductive carbon black is 11 mass % or more and 14 mass % or less.

6. The resin molded body according to claim 4,
wherein the packed bulk density of the conductive carbon black is 0.14 g/mL or more and 0.19 g/mL or less.

7. An article comprising a resin molded body,
the resin molded body comprising:
a polyacetal;
conductive carbon black; and
graphite,
wherein a content of the polyacetal in the resin molded body is 50 mass % or more,
wherein a content of the conductive carbon black in the resin molded body is 11 mass % or more and 18 mass % or less,
wherein the conductive carbon black has a dibutyl phthalate oil absorption of 320 mL/100 g or less, and
wherein the conductive carbon black has a packed bulk density specified in JIS K 5101-12-2 of 0.14 g/mL or more and 0.25 g/mL or less.

8. The article according to claim 7, wherein the article is at least one selected from the group consisting of an electrical contact member, a photosensitive drum flange, a process cartridge part, and a bearing member.
